(19) United States
(12) Patent Application Publication
(10) Pub. No.: US 2007/0277392 A1
(43) Pub. Date: Dec. 6, 2007

(54) Method for drying synthetic resin pellets

(75) Inventors: Michael Zlotos, Lauffen (DE); Hans Georg Hiller, Lautertal (DE); Achim Becker, Darmstadt (DE)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL PROTEC GMBH, Bensheim (DE)

(21) Appl. No.: 11/812,776

(22) Filed: Jun. 21, 2007

Related U.S. Application Data
(63) Continuation of application No. PCT/EP05/56603, filed on Dec. 8, 2005.

(30) Foreign Application Priority Data
Dec. 23, 2004 (DE) 10 2004 063 379.7
Jan. 31, 2005 (DE) 10 2005 004 533.2

(51) Int. Cl. F26B 3/00; C21B 13/02

(52) U.S. Cl. 34/443; 75/493; 75/495

(57) ABSTRACT

A method for drying semi-crystalline synthetic resin pellets, particularly polyethylene terephthalate (PET) pellets, according to which a heating gas is supplied to a drying vessel; synthetic resin pellets are passed countercurrently through the vessel, and the synthetic resin pellets are heated to drying temperature. Depending on pellet parameters measured at the outlet of the vessel, such as temperature, residual moisture content and/or density of the material, the temperature, quantity and/or moisture content of the heating gas supplied to the vessel are regulated.

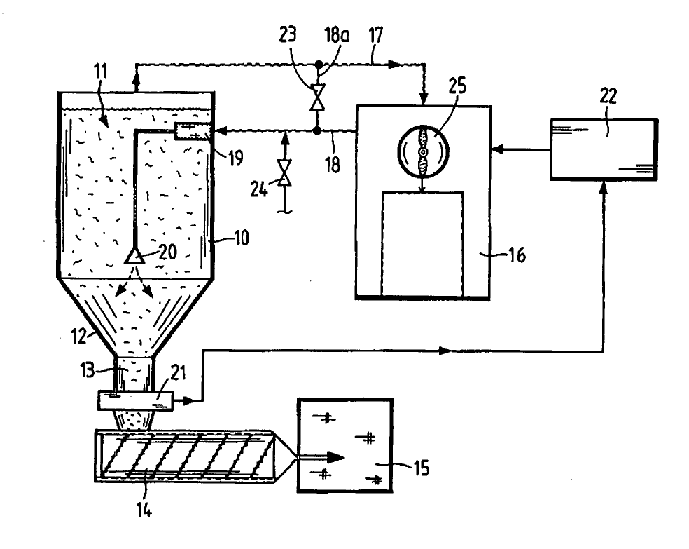

### CROSS REFERENCE TO RELATED APPLICATIONS

This application is a continuation of international patent application no. PCT/EP2005/056603, filed Dec. 8, 2005, designating the United States of America, and published in German on Jul. 6, 2006 as WO 2006/069903, the entire disclosure of which is incorporated herein by reference. Priority is claimed based on Federal Republic of Germany patent application nos. DE 10 2004 063 379.7, filed Dec. 23, 2004, and DE 10 2005 004 533.2, filed Jan. 31, 2005.

### BACKGROUND OF THE INVENTION

This invention relates to a method for drying synthetic resin pellets. The invention particularly relates to a method for producing bottle preforms from a melt of polyethylene terephthalate (PET) and/or its copolyesters for manufacturing bottles for use in the food industry. These bottles are intended, in particular, for bottling beverages, preferably carbonated beverages.

In polyester beverage bottles, the acetaldehyde content is very important. Acetaldehyde forms in small amounts during the manufacture of polyester as a result of a thermal degradation reaction. When polyester is used for food packaging, particularly for bottling beverages, even traces of acetaldehyde are problematic because acetaldehyde has a very strong odor and taste that will noticeably affect flavor. The Coca-Cola Company has defined an acetaldehyde concentration of 3 μg/l, as measured by the gas content of a newly manufactured sealed polyester bottle after 24 hours as the upper acceptable limit (Coca-Cola Standard).

To be able to meet this standard, the prior art uses a solid phase treatment of the crude polyester, which is initially produced in a molten phase. The conventional method via the solid phase comprises the following steps:

granulation of a moderately viscous melt,

crystallization of the amorphous polyester granulate, and

solid-state condensation

to obtain a granulate of a higher viscosity and a low acetaldehyde content (around 1 ppm) that is suitable for the production of bottles.

To reduce the acetaldehyde content, U.S. Pat. No. 5,656,719 (=DE 195 05 680), for example, proposes a method of optionally feeding an inert gas into the continuous stream or partial stream of polyester melt from polycondensation, which has an intrinsic viscosity of 0.5 to 0.75 dl/g, subsequently bringing the melt to an intrinsic viscosity of 0.75 to 0.95 dl/g and an acetaldehyde content of less than 10 ppm in a post-condensation screw reactor under vacuum, and then transferring it to an injection molding tool to process it into preforms.

Published European patent application no. EP 714,832 describes the production of a PET container suitable for mineral water, in which the container is produced from a preform in a production process and is washable at elevated temperatures ranging from 75° C. to 85° C. The production process is a two-step blowing/shrinking process, in which, in a first step, the preform is blown up to form an intermediate container larger in size than the final container, and the shrinking is due to the influence of heat. The shrunk container is turned into its final size in a blow molding process. This method is very complex and costly.

U.S. Pat. No. 6,559,271 (=EP 1,188,783) further discloses a method for producing polyester with a reduced content of free acetaldehyde from terephthalic acid and ethylene glycol using catalyzed polycondensation. The catalyst is added before polycondensation, and an inhibitor to deactivate the catalyst is added once an intrinsic viscosity of the melt has been reached. This method is also complex as it uses and then removes a catalyst and is disadvantageous for economic reasons.

### SUMMARY OF THE INVENTION

It is therefore an object of the invention to provide an improved method for drying synthetic resin pellets.

Another object of the invention is to provide a method for drying synthetic resin pellets which is comparatively simple to carry out and can be performed in a economical manner.

A particular object of the invention is to provide a method for drying synthetic resin pellets in which the acetaldehyde content can be adjusted to less than the known permissible values.

These an other objects have been achieved in accordance with the presently claimed invention by providing a method for drying synthetic resin pellets, said method comprising passing synthetic resin pellets through a drying vessel to a pellet outlet; supplying a heating gas to the drying vessel and conducting the heating gas countercurrently through the synthetic resin pellets passing through the drying vessel, whereby the synthetic resin pellets are heated to a crystallization temperature; sensing at least one characteristic of the synthetic resin pellets at the vessel outlet, and regulating at least one of the heating gas temperature, the amount of heating gas and the moisture content of the supplied heating gas as a function of the sensed pellet characteristics.

A significant advantage of the invention is that pellet (i.e., granulate) characteristics are measured at the outlet of the hopper and are then used to control the temperature, amount or moisture content of the supplied heating gas. This control is based on the discovery that at a certain residual moisture level of the PET, the acetaldehyde content can be lowered to below the required limit. This also means that the PET does not need to be dried completely to a minimum residual moisture level but that a certain residual moisture should be adjusted. The residual moisture can be measured at the outlet of the hopper, e.g., by means of a moisture sensor. It is also possible, however, to draw conclusions as to the moisture content from the temperature or the density or other characteristics of the material.

According to one embodiment of the invention, a moisture sensor or a capacitive measuring device suitable for measuring granulate characteristics based on changes in capacitance is disposed at the outlet of the hopper.

In a further refinement of the invention it is proposed to vary the dew point of the heating gas supplied to the hopper. A dew point sensor may be disposed in the heating gas stream and the heating gas can then be varied as a function of the measured value of the dew point sensor and the measured value at the outlet of the hopper.

In a further refinement of the invention, the dew point is varied by adding small amounts of the moist heating gas that flows out of the hopper. As an alternative, the dew point may be varied by means of the drying time or the drying temperature of the heating gas drying apparatus. A corresponding drying apparatus is described, for example, in U.S. Pat. No. 5,199,964 (=DE 39 01 779).

In another alternative embodiment, the dew point is varied by adding ambient air to the heating gas.

It has been found to be advantageous to dispose the sensor for determining the granulate characteristics in the granulate stream at the outlet of the hopper just below the narrowing of the inside diameter. In this location the sensor is also very close to the injection molding screw, so that the temperature of the material no longer changes before it enters the screw.

In an advantageous and optimized drying process, the supplied heating gas has a temperature ranging from 160° C. to 180° C. It has been found that the dew point of the supplied heating gas preferably ranges from −15° C. to '25° C. The heating gas used is preferably air or nitrogen.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWING

The invention will now be described in further detail with reference to an illustrative preferred embodiment shown in the accompanying drawing figure, which is a schematic representation of an apparatus for drying synthetic resin pellets according to the present invention.

### DETAILED DESCRIPTION OF PREFERRED EMBODIMENTS

The apparatus for drying synthetic resin pellets comprises a hopper or vessel 10 holding the synthetic resin pellets, particularly polyethylene terephthalate (PET) 11. This hopper has a funnel-shaped outlet 12. Below this outlet 12 is a cylindrical outlet fitting 13, and below the outlet fitting is an extruder 14. In front of the extruder, there is an injection mold 15 for producing the preforms.

To dry gas or air, a drying apparatus 16 is provided. Such an apparatus is known, for example, from U.S. Pat. No. 5,199,964. This drying apparatus receives moist exhaust air from the hopper 10 through line 17. The drying apparatus comprises an absorbent, e.g., silica gel and a molecular sieve. The absorbent withdraws the moisture entrained in the moist exhaust air, so that the dry air leaving the drying apparatus can be supplied to the hopper 10 through line 18. At the hopper this air is heated to the required temperature by a heating apparatus 19 and flows through an air diffuser 20 within the synthetic resin pellets.

At the outlet fitting 13 of the hopper 10 a sensor unit 21 is provided. This sensor unit determines the moisture content or the temperature of the synthetic resin pellets and transmits the signal to a data processing unit 22. The data processing unit uses this sensor signal to calculate a signal for controlling the dry air or the dry gas supplied to the hopper 10 and adjusts either the temperature of the gas to a temperature range from 160° C. to 180° C. or the moisture content of the gas supplied to the hopper 10 to a corresponding value. The moisture content can be controlled by supplying exhaust air from line 17 via a valve 23 and a bypass line 18a of line 18 or, alternatively, by supplying outside air, which is also laden with moisture, via a valve 24 of line 18. It is also possible to control the amount of drying air through the data processing unit 22, e.g., by controlling the power of the fan 25 provided in the drying apparatus 16.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A method for drying synthetic resin pellets, said method comprising:
passing synthetic resin pellets through a drying vessel to a pellet outlet;
supplying a heating gas to the drying vessel and conducting the heating gas countercurrently through the synthetic resin pellets passing through the drying vessel, whereby the synthetic resin pellets are heated to a crystallization temperature;
sensing at least one characteristic of the synthetic resin pellets at the vessel outlet, and
regulating at least one of the heating gas temperature, the amount of heating gas and the moisture content of the supplied heating gas as a function of the sensed pellet characteristics.

2. A method according to claim 1, wherein said synthetic resin pellets comprise polyethylene terephthalate or a co-polyester thereof.

3. A method according to claim 1, wherein the at least one sensed characteristic is selected from the group consisting of temperature, residual moisture content, and material density.

4. A method according to claim 1, wherein the material characteristics at the outlet of the hopper are sensed by a moisture sensor, a capacitive measuring sensor, or a temperature sensor.

5. A method according to claim 1, wherein the dew point of the heating gas supplied to the hopper is regulated as a function of the sensed pellet characteristics.

6. A method according to claim 5, wherein the dew point is varied by recirculating moist heating gas discharged from the drying vessel through a recirculation line.

7. A method according to claim 5, wherein the dew point is varied by varying at least one of the drying time and the drying temperature of a heating gas drying apparatus through which the heating gas is passed.

8. A method according to claim 5, wherein the dew point is varied by feeding ambient air into the heating gas.

9. A method according to claim 1, wherein the drying vessel is hopper having a narrowed inside diameter adjacent the outlet, and the sensor for sensing the pellet characteristics is disposed in the pellet flow at the outlet of the hopper just below the narrowing of the inside diameter.

10. A method according to claim 1, wherein the heating gas supplied to the hopper has a temperature in the range from 160° C. to 180° C.

11. A method according to claim 1, wherein the heating gas supplied to the hopper has a dew point in the range from from −15° C. to −25° C.

12. A method according to claim 1, wherein air or nitrogen is used as the heating gas.
